(19) United States
(12) Patent Application Publication
(10) Pub. No.: US 2016/0068717 A1
(43) Pub. Date: Mar. 10, 2016

(54) Multi-Layer Barrier Adhesive Film

(71) Applicant: Henkel IP & Holding GmbH, Duesseldorf (DE)

(72) Inventors: Jeffrey Gasa, Rancho Santa Margarita, CA (US); Steve Tran, Monterey Park, CA (US)

(21) Appl. No.: 14/945,524

(22) Filed: Nov. 19, 2015

Related U.S. Application Data
(63) Continuation of application No. PCT/US2014/039138, filed on May 22, 2014.
(60) Provisional application No. 61/826,573, filed on May 23, 2013.

(51) Int. Cl. C09J 123/22; B32B 27/32; B32B 37/06; C09J 7/02; B32B 37/12; B32B 37/14; B32B 27/08; B32B 27/36

(52) U.S. Cl. CPC C09J 123/22; B32B 27/08; B32B 27/32; B32B 27/36; C09J 7/0239; B32B 27/322; B32B 37/12; B32B 37/14; B32B 37/06; B32B 2250/242; B32B 2250/24; B32B 2405/00; C09J 2423/00; C09J 2427/001

(57) ABSTRACT

A multi-layer barrier adhesive is used for the encapsulation of electronic devices, such as organic light-emitting diodes (OLEDs), photovoltaics, and thin-film transistors. The multi-layer adhesive comprises at least one barrier layer disposed adjacent at least one adhesive layer. In one embodiment the barrier layer is a fluoropolymer. The fluoropolymer is preferably a homopolymer of tetrafluoroethylene (PTFE) or chlorotrifluoroethylene (PCTFE), or their copolymers.

### FIELD

This specification pertains to a multi-layer barrier adhesive film for use in the encapsulation or sealing of electronic devices, and a method of preparing the same. In one embodiment the multi-layer barrier adhesive film is a tri-layer adhesive film comprising a moisture barrier layer disposed between two adhesive layers.

### BACKGROUND

Electronic devices require moisture protection to achieve a commercially acceptable operating time or storage lifetime. The relative humidity within moisture sensitive encapsulated packages, such as organic light-emitting diodes (OLEDs), photovoltaics, and thin-film transistors, must be controlled to a sufficiently low level in order to fully protect the organic layers and electrodes. Although there are several approaches used in the prior art to protect encapsulated or packaged devices from water, these approaches do not always work.

The barrier properties of common adhesive materials, such as epoxy or acrylic resins, are insufficient to protect organic electronic devices against moisture damage. Adhesives based on polyisobutylene are known to have moisture-barrier properties. Fluoro-polymer films have even better moisture-barrier properties, but fluoro-polymer films have low adhesion or tack and are not good adhesive materials.

This creates a need to provide a barrier composition and format for that composition that has both good adhesion and good moisture-barrier properties.

### BRIEF SUMMARY

This specification is directed to a multi-layer barrier adhesive film. One embodiment is directed to a tri-layer barrier adhesive film in which a barrier film layer is disposed between two adhesive layers. In one embodiment, the adhesive layers are based on polyisobutylene (PIB) resins and/or functionalized polyisobutylene resins and the barrier layer is a fluoropolymer.

### BRIEF DESCRIPTION OF THE FIGURES

FIG. 1 depicts one process for making a tri-layer barrier adhesive film.

FIG. 2 depicts a device sealed by a multi-layer barrier adhesive film and a process for using the multi-layer barrier adhesive film to seal the moisture sensitive device.

FIG. 3 depicts a composite laminate for food and/or pharmaceutical packaging in which one embodiment of a multi-layer barrier adhesive film is used.

### DETAILED DESCRIPTION

The multi-layer barrier adhesive film comprises at least one adhesive layer bonded to at least one barrier layer. Typically, the layers are bonded in face to face orientation. In one embodiment, the multi-layer barrier adhesive film comprises at least three layers in which the first layer is an adhesive layer, the second layer is a barrier layer, and the third layer is an adhesive layer, in that order. In other embodiments, this structure can be extended to a multi-layer structure comprising more than three alternating barrier and adhesive layers. In some embodiments the barrier layer can comprise multiple layers to provide a multi-layer barrier adhesive film comprising, for example, an adhesive layer, a first barrier material layer, a second barrier material layer, and an adhesive layer.

The adhesive layers can be prepared from any adhesive resins including, but not limited to, resins selected from the group consisting of polyisobutylene (PIB) resins (such as the OPPANOL® resins available from BASF); PIB resins functionalized with acrylate or methacrylate moieties; acrylated or methacrylated polybutadiene resins (available from Sartomer and Nippon Soda); polyurethane resins (such as the ESTANE® 5700 series available from Lubrizol); hydrogenated polybutadiene resins (available from Nippon Soda and Sartomer); epoxidized-PIB, and PIB-oxetane resins (available from Henkel Corporation); epoxy resins (available as the EPON® series from Dow Chemical and the EPICLON® series from Dainippon Ink and Chemical); bismaleimide resins (such as those available as product numbers MMI-3 or 24-444A from Henkel Corporation, and as product numbers BMI-5100, BMI-TMH from Daiwakasei); epoxidized polybutadiene resins; oxetane-containing resins; acrylic polymer resins (such as the TEISAN resins from Nagase ChemteX and the PARACRON resins from Negami Chemical), and combinations of any of these resins.

PIB resins functionalized with acrylate or methacrylate moieties, such as polyisobutylene diacrylate (PIB diacrylate), are telechelic, polyisobutylene polymers with acrylate or methacrylate moieties at one or both ends of the molecule and with a molecular weight of about 1,000 to about 1,000,000; preferably about 5,000 to 25,000; advantageously about 11,000 to 14,000. As used herein molecular weights are weight average molecular weights as tested by GPC. They can be prepared using a number of known reactions schemes, some of which are listed below and the contents of which are incorporated by reference herein in their entirety.

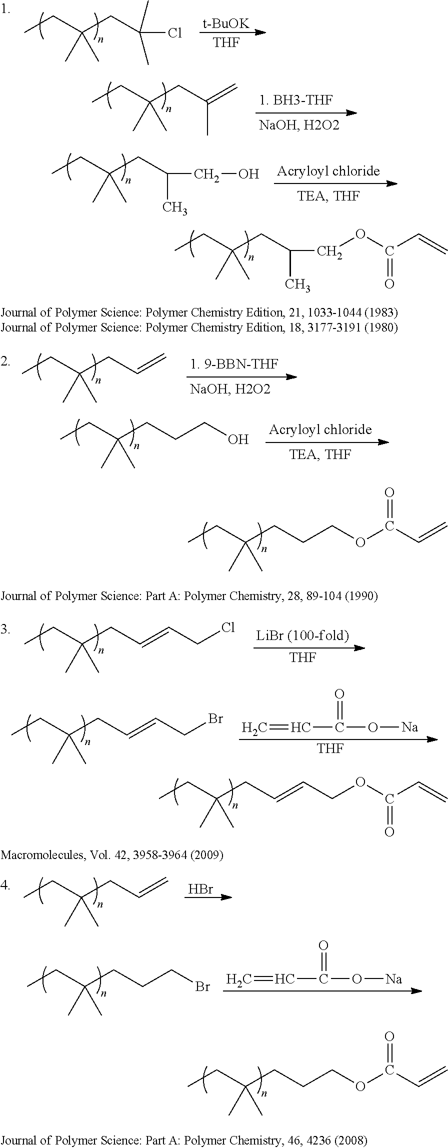

In addition, the adhesive layers can be prepared from block copolymers, such as those commercially available under the product name KRATON. Suitable block copolymers include those selected from the group consisting of styrene-ethylene/butylene-styrene (SEBS) block copolymers (G-1600 series and G-1726); styrene-isoprene-styrene (SIS) block copolymers (D-1107P, D-1111, D-1112P); styrene-butadiene-styrene (SBS) block copolymers (D-1101, D-1102, D-1116); and styrene-ethylene/propylene-styrene (SEPS) block copolymers (G-1701, G-1702).

The compositions of the different adhesive layers can be the same as, or different from, each other.

In one embodiment, the adhesive layers are prepared from PIB resins and/or acrylated or methacrylated PIB resins.

In some embodiments, the adhesive layers can include optional inorganic fillers and/or getters.

The barrier layer can comprise one or more layers. Each barrier layer is independently selected from a fluoropolymer film, a metal film, an inorganic layer, a material to sequester or absorb moisture (desiccant such as CaO or CaS) or combinations thereof.

The barrier layer in one embodiment is a fluoropolymer film. The fluoropolymer is selected from the group consisting of a homopolymer of tetrafluoroethylene (PTFE), a homopolymer of chlorotrifluoroethylene (PCTFE), and a copolymer of tetrafluoroethylene and chlorotrifluoroethylene. For applications that require optical transparency, PCTFE, or the copolymer of PCTFE with PTFE is preferred because PTFE has lower optical transparency than PCTFE. The chlorinated fluoropolymer films such as PCTFE or PTFE/PCTFE copolymer are available as ACLAR® films from Honeywell.

In other embodiments, fluoropolymer films that can be used as the barrier layer are selected from the group consisting of fluorinated ethylene propylene (FEP), perfluoroalkoxy copolymer (PFA), ethylene tetrafluoroethylene copolymer (ETFE), polyvinyl fluoride (PVF), polyvinylidene fluoride (PVDF), and copolymers of PVDF with trifluoroethylene, tetrafluoroethylene, hexafluoropropylene, or chlorotrifluoroethylene.

The fluoropolymer films PTFE, FEP, PFA, ETFE, and PVF are available from DuPont. PTFE, FEP, and PFA are sold under the TEFLON® trademark. ETFE, PVF are sold under the TEFZEL® and TEDLAR® trademarks, respectively. PVDF and its copolymers are sold under a variety of brand names including HYLAR (from Solvay), KYNAR (from Arkema), SOLEF (from Solvay), and VITON (from DuPont).

In some embodiments, the barrier layer is a metal material. Any metal that can be deposited in a suitable thickness to provide desired barrier properties is suitable. Some exemplary metal materials include Mg, Al, Fe, Ni, Cu, Pd, Ag, and Au. The metal material is deposited onto the adhesive layer or barrier film layer by vapor deposition, sputtering or other suitable process. In some embodiments, the barrier layer is an inorganic material. Suitable inorganic materials are selected from the group consisting of silica, alumina, titania, zirconia, silicon nitride, and derivatives thereof. The inorganic material is deposited onto the adhesive layer or barrier film layer by gravure coating or by vapor deposition, or any other suitable process.

In some embodiments the barrier layer is a multiple layer combination of two or more layers, each layer independently selected from a fluoropolymer film, a metal film, an inorganic material, a material to sequester or absorb moisture (desiccant such as CaO or CaS) or combinations thereof.

The tri-layer adhesive can be prepared by laminating an adhesive layer on each side of the barrier film. Suitable temperature and pressure conditions for the lamination can be determined by one skilled in the art without undue experimentation.

In various embodiments, the adhesive layers are prepared from any of the adhesive resins disclosed above. In one embodiment the adhesive resins are dissolved in a solvent appropriate for the adhesive resins and suitable for film coating. Suitable solvents for the adhesive resins include non-polar solvents such as heptane when adhesive resins are based on PIB or polybutadiene (functionalized or non-functionalized) and methyl ethyl ketone for the other adhesive resins disclosed above. The resin solution in solvent is frequently called a varnish. The varnish can be coated onto a carrier and then heated to evaporate off the solvent. The carrier can be, for example, a polyethylene terephthalate (PET) film coated with a release agent, in which embodiment it is a release liner. In other embodiments, the carrier can be a plastic film that will be utilized as the cover or cover window for the targeted device.

Upon solvent evaporation, the adhesive resin forms an adhesive layer on the carrier. In this case, the adhesive will be curable at a later time, provided the adhesive contains polymerizable resins and a curing initiator.

In some embodiments in which the adhesive layer contains polymerizable resins and a curing initiator, and a pressure sensitive adhesive (PSA) is desired, the adhesive layer can be exposed to conditions such as heat or radiation to partially or completely cure the resin to a tacky state. In this case, the adhesive will not need to be cured at a later time

In some embodiments, the adhesive resins do not polymerize when heated. In these embodiments the adhesive layer is formed by solvent evaporation only, that is, without polymerization. This embodiment occurs when the adhesive resins contain no polymerizable groups, or the adhesive resins have polymerizable groups but the composition does not contain any initiators or hardeners to polymerize the resins.

In summary, there are at least four types of adhesives that can be provided as the adhesive layers. Three of these are pressure sensitive adhesives (PSAs), that is, pressure is applied to the adhesive resin to cause adhesion, and the fourth is a cure adhesive, that is, curing of the adhesive resin is used to cause adhesion.

In one embodiment, the adhesive is a PSA prepared in the presence of a curing initiator by partially or completely curing by applying heat. Some or all of the resins in the adhesive composition are polymerizable in the presence of the curing initiator. During end-use application, the PSA is laminated onto the target device without curing after lamination.

In one embodiment, the adhesive is a PSA prepared from thermoplastic compounds that have no polymerizable groups. No curing occurs during film preparation nor during end-use application.

In one embodiment, the adhesive is a PSA that comprises at least one polymerizable resin, in the absence of a curing initiator. No curing occurs during film preparation nor during end-use application.

In one embodiment, the adhesive is not a PSA and is prepared from at least one polymerizable adhesive resin and a curing initiator. The adhesive, if in solution, can be heated at a temperature to evaporate off solvent but that is still low enough to minimize polymerization. During end-use application, the adhesive is laminated onto the target device using heat to cure the adhesive.

The initiator can be a heat-cure initiator or initiator system comprising an ingredient or a combination of ingredients which at the desired elevated temperature conditions produce free radicals. Suitable initiators may include peroxy materials, e.g., peroxides, hydroperoxides, and peresters, which under appropriate elevated temperature conditions decompose to form peroxy free radicals which are initiatingly effective for the polymerization of the adhesive composition. Dicumyl peroxide is suitable. The peroxy materials may be employed in concentrations effective to initiate curing of the adhesive composition at a desired temperature and typically in concentrations of about 0.1% to about 10% by weight of composition. Another useful class of heat-curing initiators comprises azonitrile compounds which yield free radicals when decomposed by heat. Heat is applied to the adhesive composition and the resulting free radicals initiate polymerization of the curable composition. Compounds of the above formula are more fully described in U.S. Pat. No. 4,416,921, the disclosure of which is incorporated herein by reference. Azonitrile initiators of the above-described formula are readily commercially available, e.g., the initiators which are commercially available under the trademark VAZO from E. I. DuPont de Nemours and Company, Inc., Wilmington, Del.

The initiator can be a photoinitiator. Photoinitiators enhance the rapidity of the curing process when the adhesive composition is exposed to electromagnetic radiation, such as actinic radiation. Examples of some useful photoinitiators include, but are not limited to, photoinitiators available commercially from Ciba Specialty Chemicals, under the “IRGACURE” and “DAROCUR” trade names, specifically “IRGACURE” 184 (1-hydroxycyclohexyl phenyl ketone), 907 (2-methyl-1-[4-(methylthio)phenyl]-2-morpholino propan-1-one), 369 (2-benzyl-2-N,N-dimethylamino-1-(4-morpholinophenyl)-1-butanone), 500 (the combination of 1-hydroxy cyclohexyl phenyl ketone and benzophenone), 651 (2,2-dimethoxy-2-phenyl acetophenone), 1700 (the combination of bis(2,6-dimethoxybenzoyl-2,4,4-trimethyl pentyl) phosphine oxide and 2-hydroxy-2-methyl-1-phenyl-propan-1-one), and 819 [bis(2,4,6-trimethyl benzoyl) phenyl phosphine oxide] and “DAROCUR” 1173 (2-hydroxy-2-methyl-1-phenyl-1-propan-1-one) and 4265 (the combination of 2,4,6-trimethylbenzoyldiphenyl-phosphine oxide and 2-hydroxy-2-methyl-1-phenyl-propan-1-one); and the visible light [blue] photoinitiators, dl-camphorquinone and “IRGACURE” 784DC. Of course, combinations of these materials may also be employed herein.

Other photoinitiators useful herein include alkyl pyruvates, such as methyl, ethyl, propyl, and butyl pyruvates, and aryl pyruvates, such as phenyl, benzyl, and appropriately substituted derivatives thereof.

Useful actinic radiation includes ultraviolet (UV) light, visible light, and combinations thereof. Desirably, the actinic radiation used to cure the adhesive composition has a wavelength from about 200 nm to about 1,000 nm. Useful UV includes, but is not limited to, UVA (about 320 nm to about 410 nm), UVB (about 290 nm to about 320 nm), UVC (about 220 nm to about 290 nm) and combinations thereof. Useful visible light includes, but is not limited to, blue light, green light, and combinations thereof. Such useful visible lights have a wavelength from about 450 nm to about 550 nm. Photoinitiators can be employed in concentrations effective to initiate curing of the adhesive composition at a desired exposure to actinic radiation and typically in concentrations of about 0.01% to about 10% by weight of adhesive composition.

### Exemplary Adhesive Composition Ranges:

A curable adhesive composition can comprise:

about 50 to 99 wt. % of adhesive resin; preferably about 70 to 90 wt. %.
about 0 to 30 wt. % of PIB diacrylate; preferably about 1 to 10%.
about 0 to 25 wt. % of a reactive diluent; preferably about 1 to 15 wt. %.
about 0 to 25 wt. % methacrylate monomer; preferably about 1 to 15 wt. %.
about 0.01 to 10 wt. % of an initiator; preferably about 0.1 to 1.5 wt. %.
about 0 to 25 wt. % of additives selected from one or more of catalyst, desiccant, filler, antioxidant, reaction modifier, silane adhesion promoter and rheology modifier.

The barrier film can be laminated onto the surface of the adhesive layer using a roll laminator. Lamination can be done at room temperature if the adhesive layer is tacky to finger touch, or with heat if the adhesive layer is non-tacky. The amount of heat needed will depend on the amount of tackiness of the adhesive layer. The less tacky the adhesive layer, the more heat will be required to soften the adhesive. The appropriate amount of heat can be determined by one skilled in the art without undue experimentation. Lamination pressure can range from 1 to 100 psi.

A second adhesive layer can be laminated onto the opposite side of the barrier film, thus forming a tri-layer barrier adhesive film embodiment. (The tri-layer structure excludes the carriers. The total assembled layers are five, including the top and bottom carriers, but the carriers are not considered part of the tri-layer barrier adhesive film.)

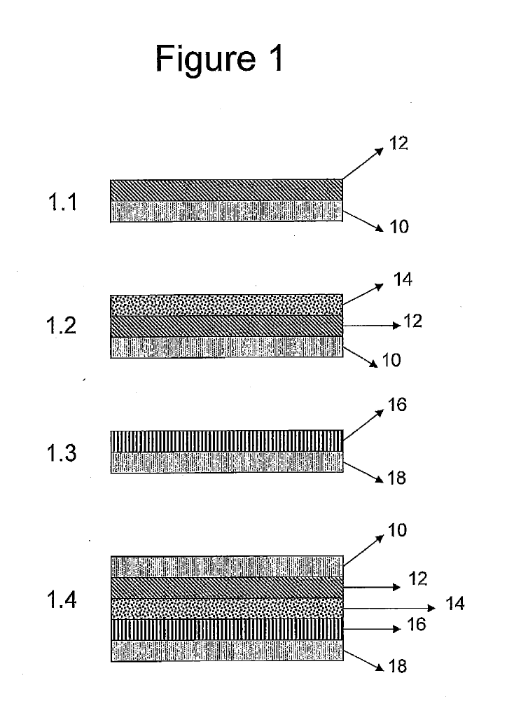

One embodiment of a process for making a tri-layer barrier adhesive film is shown in FIG. 1. In step 1.1, a first adhesive composition 12 is disposed onto a surface of a carrier 10. The adhesive composition can be a varnish coated onto a carrier and heated to evaporate off the solvent forming an adhesive layer. As described above, for some adhesive compositions, the application of heat can be used to polymerize or partially polymerize the adhesive resins. In step 1.2, a barrier film 14 is laminated to the adhesive layer 12 on the carrier 10, with the barrier film 14 in surface to surface contact with the adhesive layer 12. In some embodiments subsequent barrier materials can be disposed over the first barrier film to form barrier layer 14. The laminated barrier film and adhesive layer assembly at this point is called a dyad. In step 1.3, a second adhesive composition 16 can be disposed onto a second carrier 18. The second adhesive composition 16 can be a varnish coated onto the second carrier 18 and heated to evaporate off the solvent forming second adhesive layer 16, and for some compositions to polymerize or partially polymerize the adhesive composition resins. In step 1.4, the second adhesive layer 16 can be laminated to the barrier film 14, with the barrier film 14 in contact with the first adhesive layer 12 to provide a tri-layer barrier adhesive film (layers 12, 14, 16) with carrier layers (10, 18) on each side. The carriers 10, 18 are removed at the time the tri-layer barrier adhesive film is to be used. The above steps can be repeated to add additional barrier and adhesive layers to form a barrier adhesive film having more than three layers.

It will be understood that the above process steps do not necessarily need to be sequential. Steps 1.1 and 1.3, the preparation of the adhesive layers onto the carriers, can be performed at the same time. In other embodiments of the process, the adhesive layers can be laminated simultaneously to opposing sides of the barrier film.

One process for preparing the multi-layer barrier adhesive film comprises: (A) preparing a varnish of adhesive resin in solvent; (B) coating the adhesive varnish onto a carrier; (C) heating the adhesive varnish to evaporate off the solvent or heating the adhesive varnish to evaporate off the solvent and polymerize or partially polymerize the adhesive resin; (D) repeating steps (A), (B), and (C) until the desired number of adhesive layers is prepared; (E) providing barrier film and laminating the barrier film to one fewer of the adhesive layers prepared in steps (A), (B), and (C); and (F) assembling the barrier adhesive film from the adhesive layers and barrier layers, with the carriers removed between layers, in which the above steps are taken in any sequence that provides alternating layers of adhesive and barrier, the outermost layers being adhesive layers. The outermost adhesive layers may or may not retain the carrier, but as stated earlier, the carriers are not part of the barrier adhesive film.

These steps can be undertaken in any order and for any number of layers to provide a barrier adhesive film in which a barrier layer is disposed on one adhesive layer or is disposed between two adhesive layers.

In another embodiment, a plastic film, such as polyethylene terephthalate (PET), polyethylene naphthalate (PEN), polyethylene (PE), polypropylene (PP), polycarbonate (PC), is used in place of the carrier for one of the adhesives. In this embodiment, the plastic film does not have a release agent coated on its surface and consequently does not function as a release liner. In this embodiment, the plastic film remains adhered to the one adhesive layer. The second adhesive layer will be disposed on a release liner carrier and thus the adhesive can be exposed and used for bonding. This embodiment is useful for device encapsulation in the case in which the plastic film is the cover or cover window for the targeted device. This use requires fewer process steps during application because the encapsulating cover is already bundled with the multi-layer adhesive.

In one embodiment, the adhesive layers can be exposed to heat or radiation after lamination of the second adhesive layer to further polymerize any unreacted resins.

For device configurations that have more stringent moisture-barrier requirements than would be provided by a tri-layer barrier adhesive film, barrier adhesive films with more than three layers can be used. In these embodiments, a tri-layer barrier adhesive film is prepared as previously described and as shown in steps 1.1 to 1.4 of FIG. 1. Steps 1.1 and 1.2 then are repeated to form the partial assembly described above as a dyad. One of the carriers from the tri-layer adhesive is removed from one of the adhesive layers and the exposed adhesive layer is contacted with the barrier layer of the dyad and laminated. This is repeated until the number of desired layers is reached. Any combination of steps that provide an assembly of alternating adhesive and barrier layers can be used provided the outermost layers of the film are adhesive layers.

Some embodiments comprise an electronic device sealed with the multi-layer barrier adhesive film.

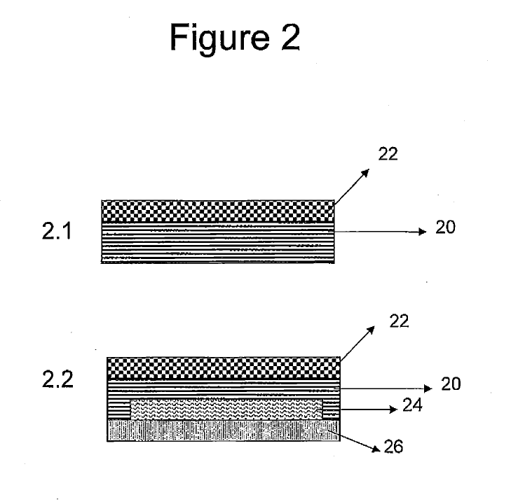

As shown in FIG. 2 the multi-layer barrier adhesive film can be used to seal a moisture sensitive device 24. In step 2.1, the multi-layer barrier adhesive film (20) (individual layers not shown for clarity) is laminated to cover film (22). In step 2.2, the combined multi-layer barrier adhesive film 20 and cover film 22 are laminated onto device (24), which is deposited onto substrate (26).

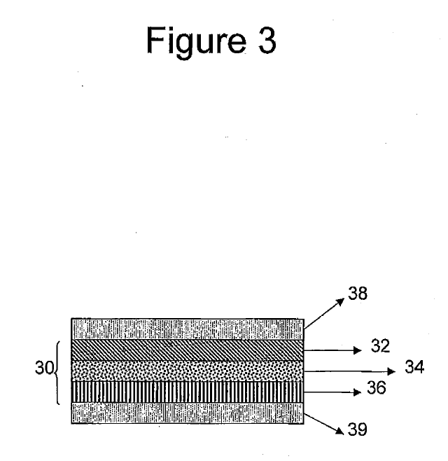

In addition to uses within the electronics industry, these multi-layer barrier adhesive films can be used as moisture-barrier adhesives in a composite for food or pharmaceutical packaging. With reference to FIG. 3, the multi-layer barrier adhesive film 30 in this embodiment comprises first adhesive layer 32, single barrier layer 34 and second adhesive layer 36. The multi-layer barrier adhesive film is disposed between a thermoplastic film 38 suitable for heat sealing, such as, for example, polypropylene, and an opposing polymer film 39 with sufficient toughness for wear resistance, such as, for example, a polyester (a wear-resistant polymer). Thus, in one embodiment, the composite comprises a thermoplastic film 38 forming one exterior surface, the barrier adhesive film 30 (comprising layers 32, 34 and 36) and a wear-resistant polymer film 39 forming the opposing exterior surface. In one embodiment, the thermoplastic film is a polypropylene; in another embodiment, the wear-resistant film is a polyester. The multi-layer barrier adhesive film barrier layer can include one or more of fluoropolymer film, metal foil, metallized polymer, or inorganic material, each suitable for prevention of the diffusion of moisture and/or oxygen. The composite is prepared in sheet form. The sheet is subsequently cut and folded so that one portion of the thermoplastic film 38 is adjacent another portion of the thermoplastic film 38. The adjoining portions of thermoplastic film can be thermally joined to form a pouch for containing food or pharmaceuticals. Polymer film 39 forms the exterior surface of the pouch and provides wear protection and a surface for marking of indicia.

### Examples

Adhesive compositions 1 and 2 were prepared. The adhesive compositions contained (amounts in grams):

| material | 1 | 2 |
|---|---|---|
| polyisobutylene¹ | 76.4 | 88.4 |
| polyisobutylene diacrylate | 3 | 8 |
| initiator² | 0.2 | 0.2 |
| initiator³ | 0.2 | 0.2 |
| reactive diluent⁴ | 14 | 2 |
| methacrylate monomer⁵ | 6 | 1 |
| bifunctional silane containing a glycidoxy reactive organic | 0.2 | 0.2 |
| group and a trimethoxysilyl inorganic group⁶ | | |

¹10% by weight solution of Oppanol B100 PIB resin (BASF) in heptane.
²Darocure 4265 available from BASF.
³dicumyl peroxide.
⁴SR423A available from Sartomer.
⁵SR421A available from Sartomer.
⁶Z6040 available from Dow Corning.

The materials were combined and mixed homogeneously. Each liquid composition was disposed onto a separate carrier and heated at 180° F. for 2 minutes, 220° F. for 3 minutes and 280° F. for 5 minutes to form an adhesive layer approximately 14 μm thick on a carrier.

A film of the above adhesive layer was laminated at room temperature to each side of a chlorotrifluoroethylene homopolymer film. The chlorotrifluoroethylene film was approximately 15 μm thick. This provided a tri-layer barrier adhesive film approximately 50 μm thick comprising the adhesive layer/chlorotrifluoroethylene film/adhesive layer.

Each tri-layer barrier adhesive film was tested for water vapor transmission rate (WVTR) using a Mocon Permatran-W 3/33 set at 38° C., 100% relative humidity (RH), high barrier, low transmission blue standard and a gas flow rate of 10 SCCM. Testing results are shown in the following Table.

| | Sample | WVTR grams/(100 in²- | Permeability grams- |
|---|---|---|---|
| Sample | thickness (mils) | day)@100% RH | mil/100 in²-day |
| 2 | 2.7 | 0.0222 | 0.0604 |

Adhesive composition 3 was prepared. The adhesive composition contained (amounts in grams):

| material | 3 |
|---|---|
| polyisobutylene¹ | 76.4 |
| polyisobutylene diacrylate | 3 |
| initiator² | 0.2 |
| initiator³ | 0.2 |
| reactive diluent⁴ | 14 |
| methacrylate monomer⁵ | 6 |
| bifunctional silane containing a glycidoxy reactive organic | 0.2 |
| group and a trimethoxysilyl inorganic group⁶ | |

¹10% by weight solution of Oppanol B100 PIB resin (BASF) in heptane.
²Darocure 4265 available from BASF.
³dicumyl peroxide.
⁴SR423A available from Sartomer.
⁵SR421A available from Sartomer.
⁶Z6040 available from Dow Corning.

The materials were combined and mixed homogeneously. Composition 3 was disposed onto a carrier and heated at 180° F. for 2 minutes, 220° F. for 3 minutes and 280° F. for 5 minutes to form an adhesive layer approximately 14 μm thick on a carrier.

A film of the above adhesive layer was laminated at room temperature to each side of a chlorotrifluoroethylene homopolymer film. The chlorotrifluoroethylene film was approximately 22 μm thick. This was repeated three times to provide three, tri-layer barrier adhesive films approximately 50 μm thick comprising the adhesive layer/chlorotrifluoroethylene film/adhesive layer.

Each tri-layer barrier adhesive film was tested for water vapor transmission rate (WVTR) using a Mocon Permatran-W 3/33 set at 38° C., 100% relative humidity (RH), high barrier, low transmission blue standard and a gas flow rate of 10 SCCM. Testing results are shown in the following Table.

| | Sample | WVTR grams/(100 in²- | Permeability grams- |
|---|---|---|---|
| Sample | thickness (mils) | day)@100% RH | mil/100 in²-day |
| 3a | 2 | 0.427 | 0.858 |
| 3b | 2 | 0.232 | 0.466 |
| 3c | 2 | 0.810 | 1.627 |

1. A multi-layer barrier adhesive film comprising an adhesive composition layer disposed over a barrier layer wherein the adhesive composition comprises an adhesive resin is selected from the group of resins consisting of polyisobutylene; acrylated or methacrylated polyisobutylene; acrylated or methacrylated polybutadiene; polyurethane; hydrogenated polybutadiene; epoxidized-polyisobutylene; polyisobutylene-oxetane; epoxy; bismaleimide; epoxidized polybutadiene; oxetane; acrylic polymer resins; block copolymers; and combinations of any of these resins.

2. The multi-layer barrier adhesive film according to claim 1 comprising at least three layers in which the barrier layer is disposed between two adhesive resin layers.

3. (canceled)

4. The multi-layer barrier adhesive film according to claim 1 in which the adhesive resin is selected from the group of resins consisting of polyisobutylene; acrylated or methacrylated polyisobutylene; and acrylated or methacrylated polybutadiene; and combinations of any of these resins.

5. The multi-layer barrier adhesive film according to claim 1 in which the adhesive resins are block copolymers selected from the group consisting of styrene-ethylene/butylene-styrene (SEBS) block copolymer; styrene-isoprene-styrene (SIS) block copolymer; styrene-butadiene-styrene (SBS) block copolymer; and styrene-ethylene/propylene-styrene (SEPS) block copolymer; and combinations thereof.

6. The multi-layer barrier adhesive film according to claim 1 in which the barrier layer is selected from at least one of fluoropolymer film, metal film, metallized polymer, inorganic material and desiccant, each suitable for lowering the diffusion of moisture and/or oxygen through the multi-layer barrier adhesive film.

7. The multi-layer barrier adhesive film according to claim 1 in which the barrier film is a fluoropolymer film comprising a homopolymer of tetrafluoroethylene, a homopolymer of chlorotrifluoroethylene, a copolymer of tetrafluoroethylene and chlorotrifluoroethylene, fluorinated ethylene propylene, perfluoroalkoxy copolymer, ethylene tetrafluoroethylene copolymer, polyvinyl fluoride, polyvinylidene fluoride and copolymers of polyvinylidene fluoride with trifluoroethylene, tetrafluoroethylene, hexafluoropropylene, or chlorotrifluoroethylene.

8. The multi-layer barrier adhesive film according to claim 1 in which the barrier layer is an inorganic material comprising at least one of silica, alumina, titania, zirconia, silicon nitride, and derivatives thereof.

9. The multi-layer barrier adhesive film according to claim 1 in which the barrier layer is an inorganic material comprising at least one of silica, alumina, titania, zirconia, silicon nitride, and derivatives thereof, the inorganic material being deposited onto the adhesive layer by gravure coating or by vapor deposition.

10. The multi-layer barrier adhesive film of claim 1 consisting of two layers, the adhesive resin layer and the barrier layer.

11. An article comprising the multi-layer barrier adhesive film of claim 1 or cured reaction products of the multi-layer barrier adhesive film of claim 1.

12. A packaged electronic device comprising the multi-layer barrier adhesive film of claim 1 or cured reaction products of the multi-layer barrier adhesive film of claim 1.

13. The barrier adhesive film of claim 1 disposed between a thermoplastic film suitable for heat sealing and a wear resistant polymer film.

14. The barrier adhesive film of claim 1 disposed between a polyolefin thermoplastic film suitable for heat sealing and a wear resistant polymer film.

15. The barrier adhesive film of claim 1 disposed between a thermoplastic film suitable for heat sealing and a wear resistant polyester polymer film.

16. A process for preparing a multi-layer barrier adhesive film according to claim 1 comprising:
(A) preparing the adhesive composition of claim 1;
(B) disposing the adhesive composition onto a carrier to form an adhesive layer;
(C) repeating steps (A) and (B) until the desired number of adhesive layers is prepared;
(D) providing a barrier film and laminating the barrier film to one fewer of the adhesive layers prepared in steps (A), (B), and (C); and
(E) assembling the multi-layer barrier adhesive film from the adhesive layers and barrier layers, with the carriers removed between layers, in which the above steps are taken in any sequence that provides alternating layers of adhesive and barrier, the outermost layers being adhesive layers.

17. The process according to claim 16 wherein the adhesive composition is a varnish of adhesive resin in solvent; and further comprising the step of heating the adhesive varnish disposed on the carrier to evaporate off the solvent or heating the adhesive varnish to evaporate off the solvent and polymerize or partially polymerize the adhesive resin.

18. The process according to claim 16 in which the steps are undertaken in any order and for any number of layers to provide a barrier adhesive film in which a barrier layer is deposited on one adhesive layer or disposed between two adhesive layers.

19. The process according to claim 16 in which a plastic film without release agent is used in place of the carrier for one of the adhesive layers.
